(19) United States
(12) Patent Application Publication
(10) Pub. No.: US 2016/0022030 A1
(43) Pub. Date: Jan. 28, 2016

(54) DESKTOP RECEPTACLE WITH FLIP COVER

(71) Applicant: Group Dekko, Inc., Garrett, IN (US)

(72) Inventors: Sean J. Scott, Chicago, IL (US); Jillian Pai, Chicago, IL (US)

(73) Assignee: GROUP DEKKO, INC., Garrett, IN (US)

(21) Appl. No.: 14/444,367

(22) Filed: Jul. 28, 2014

(51) Int. Cl. A47B 21/06; H01R 13/516; H01R 13/66; H01R 13/631

(52) U.S. Cl. CPC A47B 21/06; H01R 13/6315; H01R 13/516; H01R 13/6675; A47B 2021/068

(57) ABSTRACT

A desktop receptacle assembly includes a box and an electrical connection assembly held within the box that includes a cover. The electrical connection assembly is configured to have an exposed position and a concealed position within the box. A pivoting member connects the electrical connection assembly to the box and defines an axis of rotation. The pivoting member is configured to allow the electrical connection assembly to rotate at least 90 degrees about the axis of rotation and flip between the exposed position and the concealed position.

### BACKGROUND OF THE INVENTION

1. Field of the Invention

The present invention relates to boxes, and, more particularly, to boxes that hold electrical connection components.

2. Description of the Related Art

Desktop receptacles are known that can be connected to an electrical or data source, such as a wall outlet or computer, and installed in a work area to allow for electronic devices in the work area to connect to the wall outlet or computer. For aesthetic purposes, it is desirable that an installed desktop receptacle is hidden from sight. This can be accomplished by installing the desktop receptacle in an out of sight location of the work area, such as underneath a desk. In such cases, it can be difficult to access the desktop receptacle to connect electronic devices.

What is needed in the art is a desktop receptacle that can be easily accessed and hidden out of sight in a work area.

### SUMMARY OF THE INVENTION

The present invention provides a desktop receptacle assembly that can be installed within a work surface and has a pivoting member that allows for an electrical connection assembly held within the desktop receptacle assembly to switch between an exposed and a concealed position.

The invention in one form is directed to a desktop receptacle assembly that includes a box, an electrical connection assembly held within the box that includes a cover and is configured to have an exposed position and a concealed position, and a pivoting member connecting the electrical connection assembly to the box and defining an axis of rotation. The pivoting member is configured to allow the electrical connection assembly to rotate at least 90 degrees about the axis of rotation and flip between the exposed position and the concealed position.

The invention in another form is directed to a work area that includes a work surface with an opening formed through and a desktop receptacle assembly held within the opening. The desktop receptacle assembly includes a box, an electrical connection assembly held within the box that includes a cover and is configured to have an exposed position and a concealed position, and a pivoting member connecting the electrical connection assembly to the box and defining an axis of rotation. The pivoting member is configured to allow the electrical connection assembly to rotate at least 90 degrees about the axis of rotation and flip between the exposed position and the concealed position.

An advantage of the present invention is that electronic devices can be easily connected to the electrical connection assembly in the exposed position before switching the electrical connection assembly to the concealed position.

Another advantage is that the desktop receptacle assembly does not disrupt a work surface when it is in the concealed position.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of an embodiment of the present invention with the electrical connection assembly in a concealed position;

FIG. 2 is a perspective view of the embodiment shown in FIG. 1 with the electrical connection assembly in an exposed position;

FIG. 3 is a cross-sectional view of the embodiment as shown in FIG. 1 taken along line 3-3;

FIG. 4 is a cross-sectional view of the embodiment as shown in FIG. 2 taken along line 4-4; and

FIG. 5 is an exploded view of the embodiment shown in FIG. 1.

Corresponding reference characters indicate corresponding parts throughout the several views. The exemplification set out herein illustrates one embodiment of the invention and such exemplification is not to be construed as limiting the scope of the invention in any manner.

### DETAILED DESCRIPTION OF THE INVENTION

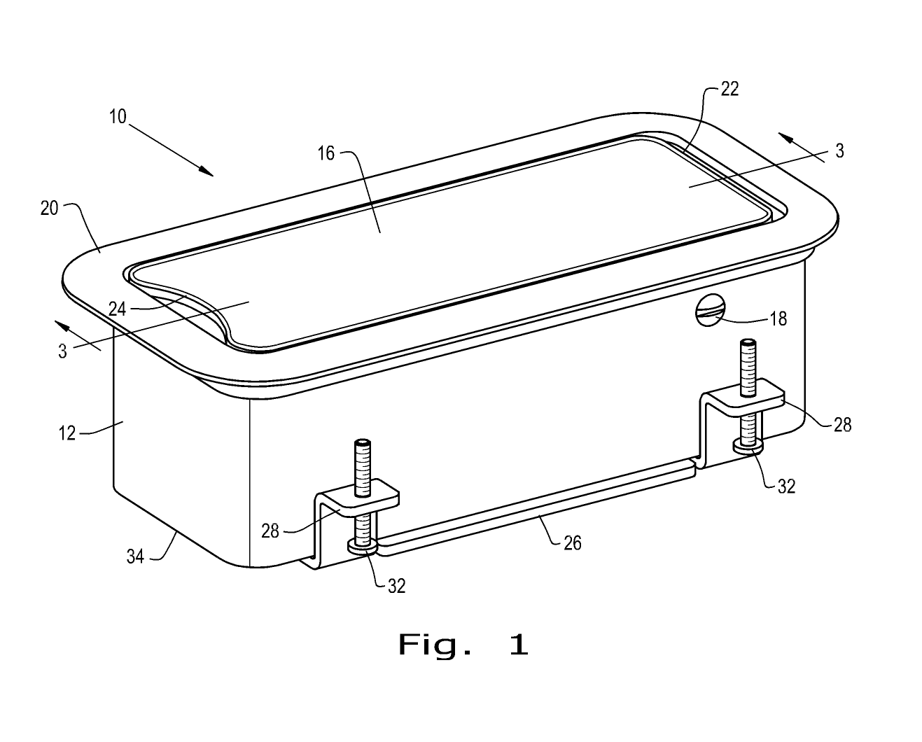

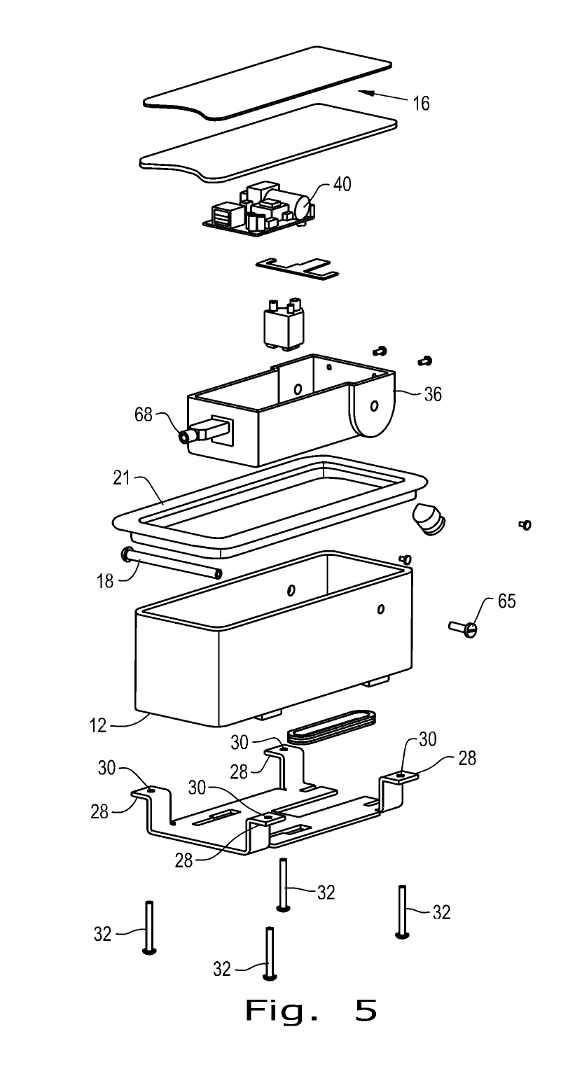

Referring now to the drawings, and more particularly to FIG. 1, there is shown a desktop receptacle assembly 10 which generally includes a box 12, an electrical connection assembly 14 with attached cover 16 held within the box 12, and a pivoting member 18 that connects the electrical connection assembly 14 to the box 12. As shown, the electrical connection assembly 14 is in a concealed position, with the cover 16 being mostly flush with a top surface 20 of the box 12. The box 12 is shown as having a rectangular shape, but other shapes and sizes can be used so long as they can hold the electronic connection assembly 14 within and allow for the pivoting action of the present invention. In the concealed position, the electrical connection assembly 14 is mostly hidden from view, with the cover 16 being visible. The cover 16 can be made from multiple materials, as shown, or a single material, depending on the user's aesthetic preferences. The electrical connection assembly 14 is held within an opening 22 formed in the box 12, which is large enough to accommodate all the parts of the electrical connection assembly 14. The cover 16 can have a groove 24 cut into its surface that provides a gripping surface for a user to manually flip the electrical connection assembly 14 into an exposed position, which will be described below. The desktop receptacle assembly 10 can have a mount 26 attached that includes brackets 28. The brackets 28 can each have a threaded opening 30 (shown in FIG. 5) that allows for a corresponding threaded screw 32 to be advanced through. When the desktop receptacle assembly 10 is placed through a work surface, the threaded screw(s) 32 can be advanced through the threaded opening(s) 30 from a bottom 34 of the box 12 toward the work surface. The threaded screw(s) 32 can be advanced into the bottom of the work surface as desired to tighten the desktop receptacle assembly 10 to the work surface.

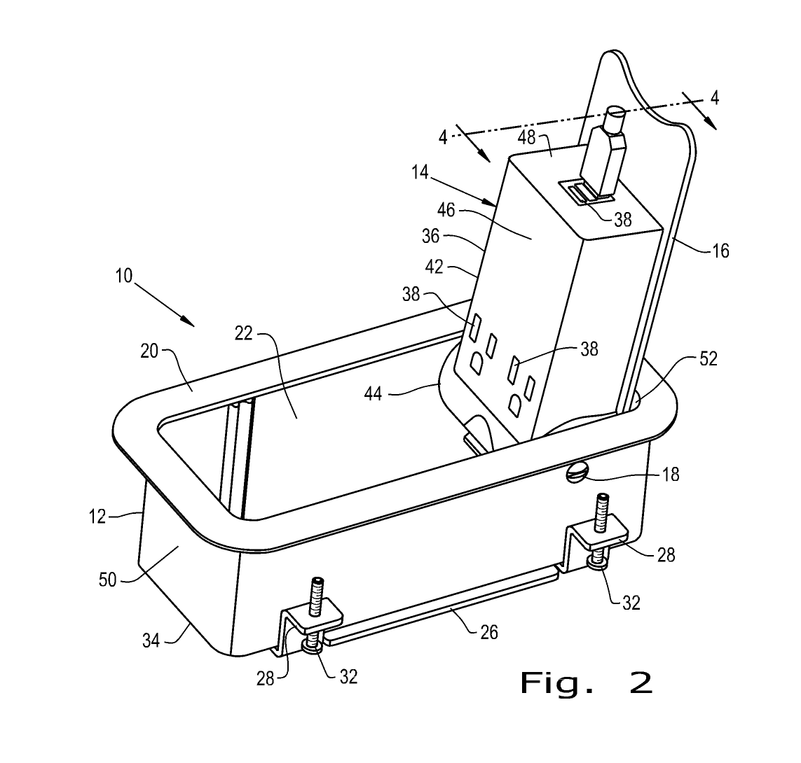

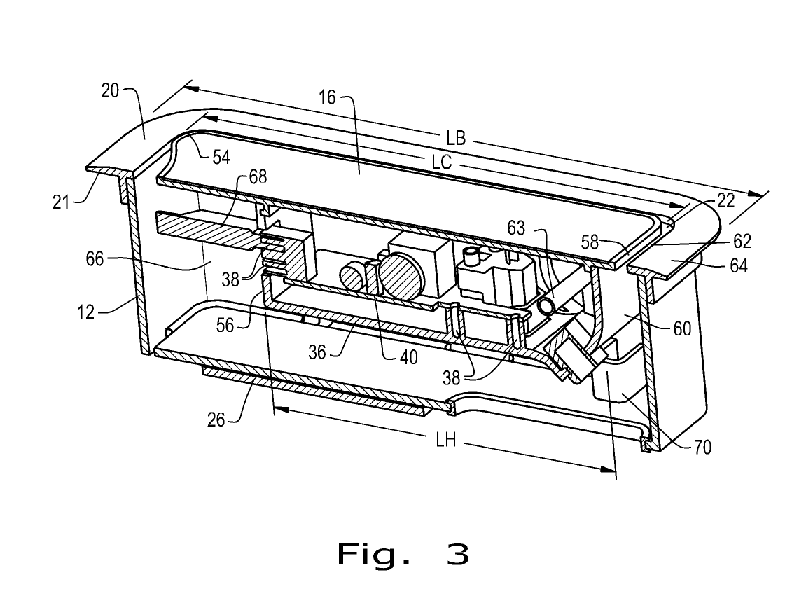

Referring now to FIG. 2, the desktop receptacle assembly 10 shown in FIG. 1 is shown with the electrical connection assembly 14 in an exposed position. As can be seen, the electrical connection assembly 14 includes an assembly housing 36 with electrical connectors 38 exposed. The electrical connectors 38 are coupled to an electrical board 40 (shown in FIGS. 3-6) and can be a variety of different connectors. The electrical connectors 38 can be data ports, e.g., a universal serial bus (USB) port, a high-definition media interface (HDMI) port, an Ethernet port, a coaxial cable port, etc., and/or electrical ports that can provide electrical power to connected devices. The assembly housing 36 is shown as having a rectangular box section 42 with a cylindrical section 44 attached, but the assembly housing 36 could take any shape that allows for the electrical connection assembly 14 to pivot in and out of the box 12. The rectangular box section 42 has a bottom surface 46 which will face the bottom 34 of the box 12 in the concealed position and can be where openings for electrical connectors 38 are located. As shown, the bottom surface 46 includes openings for a pair of grounded electrical connections 38, but openings for other electrical or data ports could be included on the bottom surface 46. The assembly housing 36 can also have a side surface 48, which will face a side 50 of the box 12 in the concealed position, with an opening for electrical connectors 38, shown as USB ports.

As can be seen, when the electrical connection assembly 14 is in its exposed position, the electrical connectors 38 can be easily accessed by a user to connect devices. The user can manually switch the electrical connection assembly 14 from the concealed position to the exposed position by flipping the cover 16 up at the groove 24, which causes the electrical connection assembly 14 to rotate about the pivoting member 18. In this sense, the pivoting member 18 acts as an axis of rotation for the connection assembly 14. The electrical connection assembly 14 can be rotated at least 90 degrees in this arrangement, allowing for a larger surface area of the assembly 14 to be exposed and potentially utilized for connecting electronic devices. The arrangement of the electronic connection assembly 14 and the box 12 can allow the assembly 14 to be rotated about the pivoting member 18 until the cover 16 comes into contact with a side 52 of the box 12, which acts as a stop for the electronic connection assembly 14, or a brake (described below) within the box 12. Although the side 52 which can act as a stop is shown as being oriented clockwise relative to the pivoting member 18, side 52 could also be oriented counter-clockwise relative to the pivoting member 18. Alternatively, the assembly housing 36 can be shaped so that it contacts the bottom 34 of the box 12 at the desired maximum degree of rotation to prevent further rotation about the pivoting member 18.

Referring now to FIG. 3, a cross-section of the desktop receptacle assembly 10 in the concealed position is shown. As previously described, the box 12 has top surface 20 that is mostly flush with the cover 16 when the electrical connection assembly 14 is in the concealed position. If desired, the electrical connection assembly 14 could be set deeper into the box 12 so that there is a vertical divide between the top surface 20 and the surface of the cover 16. The top surface 20 can also be an integral part of the box 12, or could be a separable flange 21 that is placed on the perimeter of the box 12 and provides a surface to better attach the desktop receptacle assembly 10 to a work surface. As can be seen, the electrical connecting assembly 14 has an electrical board 40 included within the assembly housing 36. The electrical board 40 is coupled to the electrical connectors 38 and connects to a wall outlet (not shown) to provide power to the electrical connectors 38. The electrical board 40 can also be configured to communicate either wired or wirelessly with other electrical devices in order to share data through data ports.

The assembly housing 36 has a housing length LH and the cover 16 has a cover length LC that are both parallel to the bottom 34 of the box 12 in the concealed position. The cover 16 has an end 54 adjacent the groove 24 that extends past end 56 of the assembly housing 36 and another end 58 that extends past end 60 of the assembly housing 36. The box 12 can have a box length LB, that is greater than the housing length LH and cover length LC on both ends, that gives a clearance 62 between the box 12, electrical connection assembly 14 and cover 16 at end 64 of the box 12 and, optionally, another clearance 66 between the box 12 and electrical connection assembly 14 at side 52 of the box 12. Optional clearance 66 is shown as being significantly longer than clearance 62 so that a device 68 connected to electrical connector 38 on the side surface 48 of the assembly housing 36 can be concealed within the box 12 when the electrical connection assembly 14 is in the concealed position, but clearance 62 can be adjusted to be an equal or greater length than clearance 66 if desired. Clearance 62, as shown, is necessary to allow for the electrical connection assembly 14 to rotate more than 90 degrees relative to the pivoting member 18, but if a lower degree of rotation is desired then clearance 62 could be optional.

The pivoting member 18 connects the electrical connection assembly 14 to the box 12 and allows the electrical connection assembly 14 to rotate about an axis of rotation defined by the pivoting member 18. As can be seen, the pivoting member 18 can go completely through the box 12 and assembly housing 36 in a direction that is perpendicular to the lengths of the box 12 and housing 36. This allows for the electrical connection assembly 14 to “swing out” of its concealed position in the box 12 to the exposed position. The pivoting member 18 can fit within a cylinder 63 that is an integral part of the assembly housing 36 or attached to the assembly housing 36. The pivoting member 18 can be held in the cylinder 63 by a variety of methods, such as threading within the pivoting member 18 that corresponds to threading on a locking screw 65 (shown in FIG. 5) which has a screw head with a larger diameter than an opening of the cylinder 63 that the pivoting member 18 is inserted through. The pivoting member 18, which has a screw head that is also larger than the opening of the cylinder 63, is placed within the cylinder 63 and the locking screw 65 is threaded into the pivoting member 18, holding it within the cylinder 63. Other suitable methods could also be employed to maintain the pivoting member 18 as the axis of rotation for the electrical connection assembly 14. Although the pivoting member 18 is shown as going through two opposing sides of both the box 12 and the electrical connection assembly 14, it is contemplated that the pivoting member 18 can go through one side of the box 12 or assembly 14 or two opposing sides of just the assembly 14.

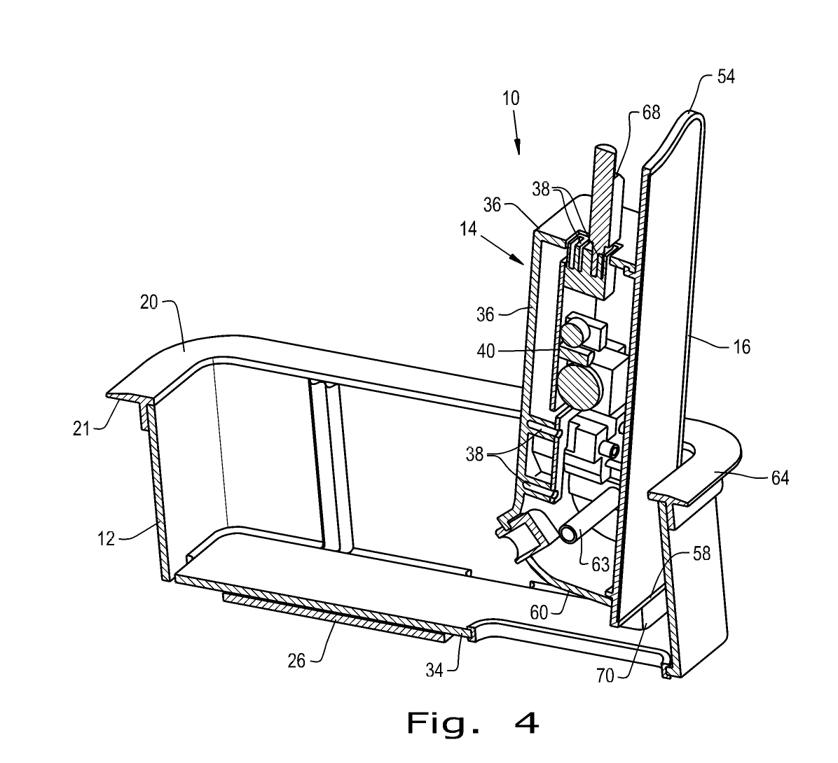

Referring now to FIG. 4, a cross-section of the electrical connection assembly 14 in the exposed position is shown. As can be seen, the electrical connection assembly 14 has been rotated more than 90 degrees relative to the pivoting member 18. To prevent further rotation of the electrical connection assembly, a brake 70 can be formed on the bottom 34 of the box 12 that the cover 16 will abut against at a certain degree of rotation. The brake 70 is sufficiently tall to prevent further rotation of the electrical connection assembly 14 by impeding the rotational path of the cover 16. While the brake 70 is shown as being placed on the bottom 34 of the box 12, it could be placed at other locations in the box 12 so long as it does not interfere with rotation of the electrical connection assembly 14 until a desired maximum degree of rotation about the pivoting member 18 has occurred.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A desktop receptacle assembly, comprising:
a box;
an electrical connection assembly held within said box including a cover, said electrical connection assembly configured to have an exposed position and a concealed position within said box; and
a pivoting member connecting said electrical connection assembly to said box and defining an axis of rotation, said pivoting member configured to allow said electrical connection assembly to rotate at least 90 degrees about said axis of rotation and flip between said exposed position and said concealed position.

2. The desktop receptacle assembly according to claim 1, wherein said box has a top surface, said cover having a cover surface that is substantially parallel with said top surface in said concealed position and extends past said top surface in said exposed position.

3. The desktop receptacle assembly according to claim 2, wherein said cover surface is co-planar with said top surface in said concealed position.

4. The desktop receptacle assembly according to claim 1, wherein said electrical connection assembly includes an assembly housing, an electrical board held within said housing and at least one electrical connector coupled to said electrical board.

5. The desktop receptacle assembly according to claim 4, wherein said at least one electrical connector is at least one of a data port and an electrical port.

6. The desktop receptacle assembly according to claim 5, wherein said data port is at least one of a universal serial bus (USB) port, a high-definition multimedia interface (HDMI) port, an Ethernet port and a coaxial cable port.

7. The desktop receptacle assembly according to claim 5, wherein said electrical port is configured to provide electrical power to a connected device.

8. The desktop receptacle assembly according to claim 4, wherein said assembly housing has a first surface with a first pivot opening formed through, said pivoting member going through said first pivot opening.

9. The desktop receptacle assembly according to claim 8, wherein said assembly housing has a second surface opposed to said first surface with a second pivot opening formed through, said pivoting member going through said second pivot opening.

10. The desktop receptacle assembly according to claim 4, wherein said cover has a cover length and said assembly housing has a housing length that is less than said cover length.

11. The desktop receptacle assembly according to claim 10, wherein said box has a box length that is greater than said cover length.

12. The desktop receptacle assembly according to claim 11, wherein a gap is formed between said cover and said box, said gap having a gap length equal to the difference between said box length and cover length.

13. The desktop receptacle assembly according to claim 12, wherein said cover has a thickness, said thickness being smaller than said gap length.

14. The desktop receptacle assembly according to claim 1, further including a brake within said box configured to prevent said electrical connection assembly from rotating more than a desired maximum degree of rotation relative to said axis of rotation.

15. The desktop receptacle assembly according to claim 1, wherein said electrical connection assembly is configured to be manually switched between said exposed position and said concealed position.

16. A work area, comprising:
a work surface having an opening formed therein; and
a desktop receptacle assembly held within said opening, said desktop receptacle assembly including:
a box;
an electrical connection assembly held within said box including a cover, said electrical connection assembly configured to have an exposed position and a concealed position within said box; and
a pivoting member connecting said electrical connection assembly to said box and defining an axis of rotation, said pivoting member configured to allow said electrical connection assembly to rotate at least 90 degrees about said axis of rotation and flip between said exposed position and said concealed position.

17. The work area according to claim 16, wherein said work surface is a surface of a desk.
